(19) United States
(12) Patent Application Publication
(10) Pub. No.: US 2024/0378084 A1
(43) Pub. Date: Nov. 14, 2024

(54) METHODS AND APPARATUS FOR PROCESSING DATA

(71) Applicant: Arm Limited, Cambridge (GB)

(72) Inventors: Elliot Maurice Simon Rosemarine, London (GB); Alexander Eugene Chalfin, Mountain View, CA (US); Ozgur Tasdizen, Cambridge, Cambridgeshire (GB); Tord Kvestad Øygard, Kirkenes, Troms og Finnmark (NO)

(21) Appl. No.: 18/316,125

(22) Filed: May 11, 2023

(51) Int. Cl. G06F 9/50

(52) U.S. Cl. CPC G06F 9/5027

(57) ABSTRACT

According to the present techniques there is provided a method of operating a data processor unit to generate processing tasks: the data processor unit comprising: a control circuit to receive, from a host processor unit, a request for the data processor unit to perform a processing job; an iterator unit to process the request and generate a workload comprising one or more tasks for the requested job; one or more execution units to perform the one or more tasks; storage to store system information indicative of a status of at least one component of the data processor unit; the method comprising: receiving, at the control circuit, a first request to perform a first processing job; processing, at the iterator unit, the first request and generating a workload comprising one or more tasks for the first processing job based on or in response to the system information in storage, wherein at least one characteristic of the workload is dependent on the system information.

The present techniques generally relate to the field of data processing.

A data processing system may include number of general-purpose processor units and one or more target processor units. Example target processor units include a graphics processor unit (GPU), an array processor, a cryptographic engine, a neural processor unit (NPU) and a digital signal processor (DSP).

The present technology relates to the control of parallel programs in such data processing systems where there exists a need to provide improved processing of data.

According to a first technique there is provided a computer implemented method of operating a data processor unit to generate processing tasks: the data processor unit comprising: a control circuit to receive, from a host processor unit, a request for the data processor unit to perform a processing job; an iterator unit to process the request and generate a workload comprising one or more tasks for the requested job; one or more execution units to perform the one or more tasks; storage to store system information indicative of a status of at least one component of the data processor unit; the method comprising: receiving, at the control circuit, a first request to perform a first processing job; processing, at the iterator unit, the first request and generating a workload comprising one or more tasks for the first processing job based on or in response to the system information in storage, wherein at least one characteristic of the workload is dependent on the system information.

According to a further technique there is provided a data processor unit to generate processing tasks: the data processor unit comprising: a control circuit to receive, from a host processor unit, a request for the data processor unit to perform a processing job; an iterator unit to process the request and generate a workload comprising one or more tasks for the requested job; one or more execution units to perform the one or more tasks; storage to store system information indicative of a status of at least one component of the data processor unit; wherein the iterator unit is to generate the workload comprising one or more tasks for the requested job based on or in response to the system information in storage such that at least one characteristic of the workload is dependent on the system information, and where the iterator unit is to output the one or more tasks for distribution to one or more execution units.

According to a further technique there is provided a non-transitory data carrier carrying code which, when implemented on a processor, causes the processor to carry out the methods described herein.

The techniques are diagrammatically illustrated, by way of example, in the accompanying drawings, in which:

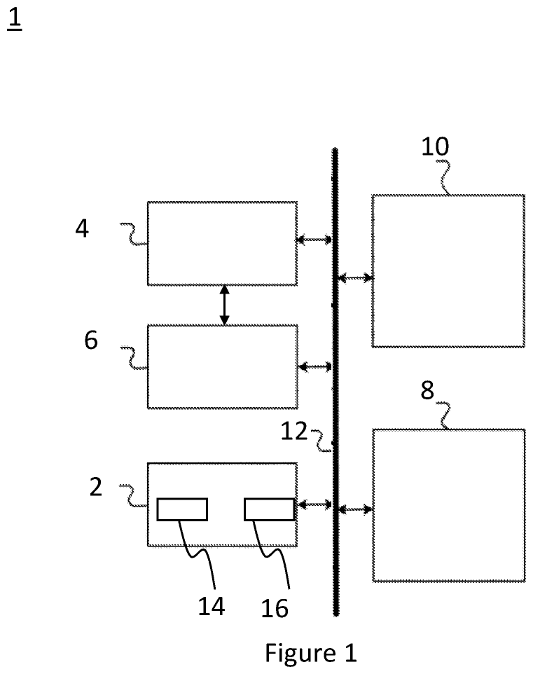

FIG. 1 schematically shows a simplified block diagram of a data processing system in accordance with an embodiment;

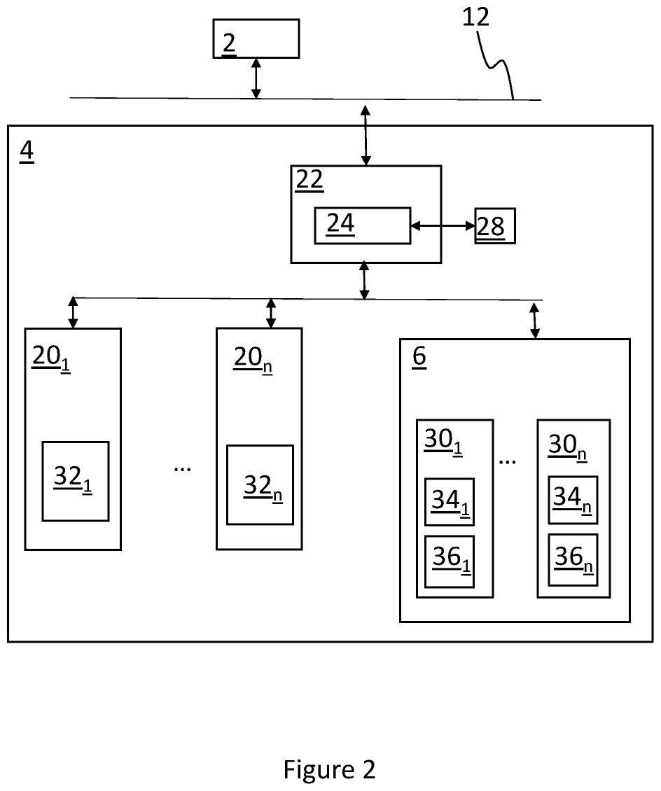

FIG. 2 schematically shows a simplified block diagram of a target processor,

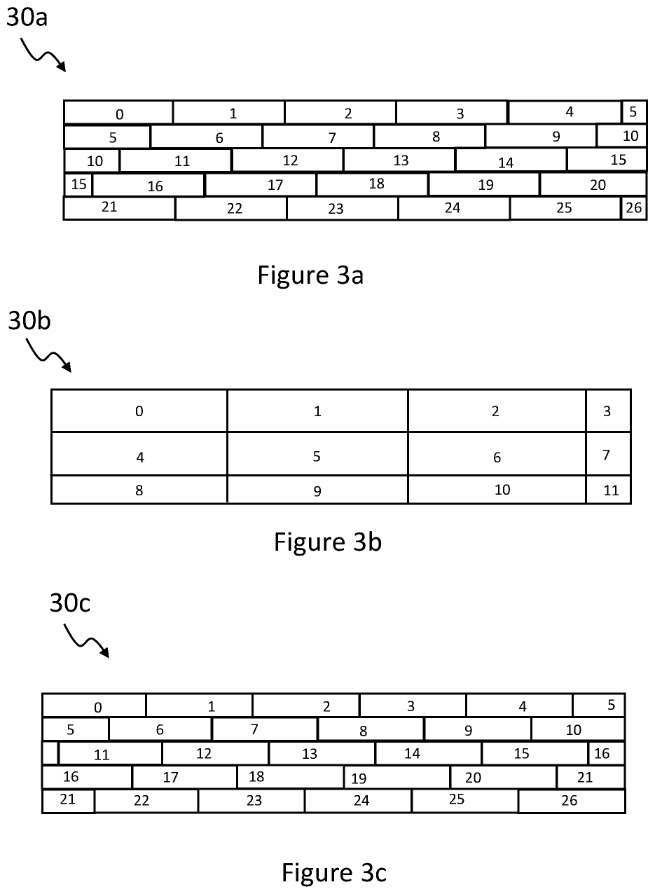

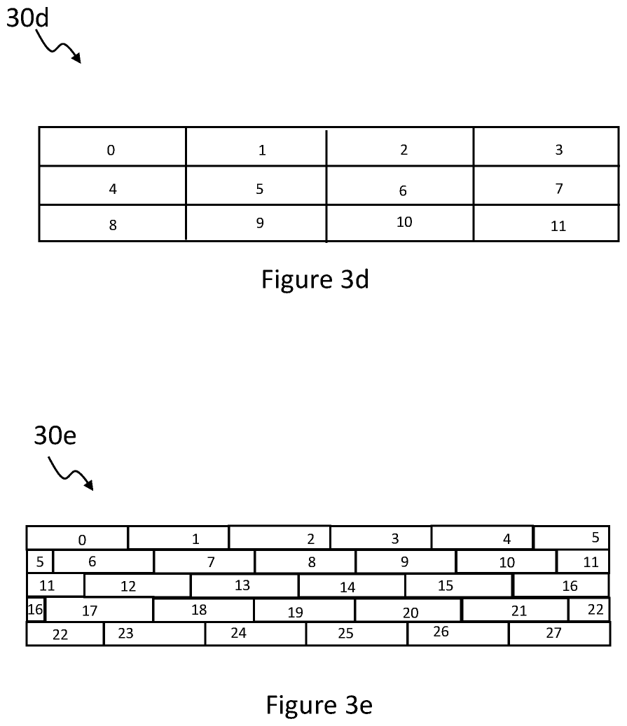

FIGS. 3a-3e schematically show example iteration space for respective processing jobs;

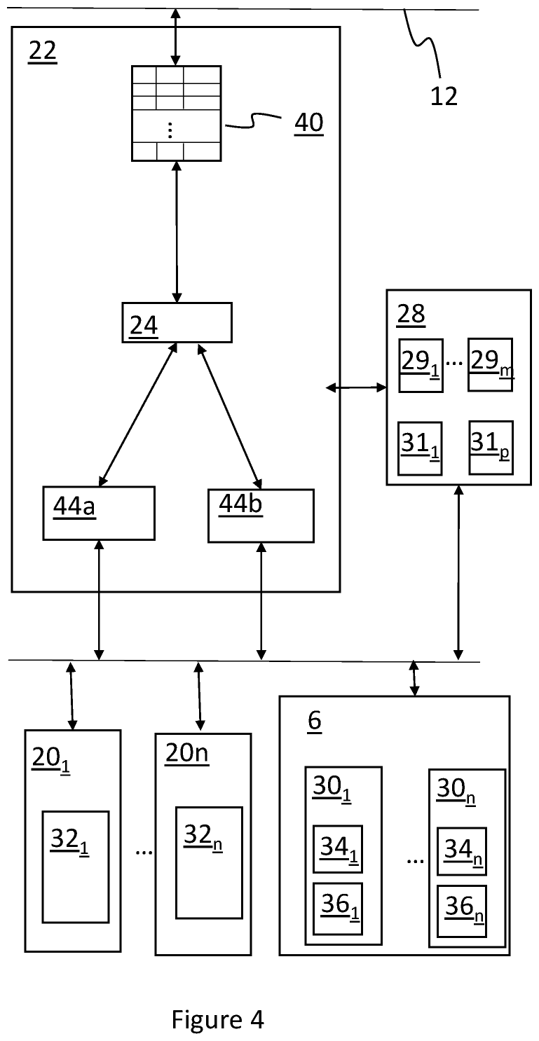

FIG. 4 schematically shows a further simplified block diagram of the target processor; and

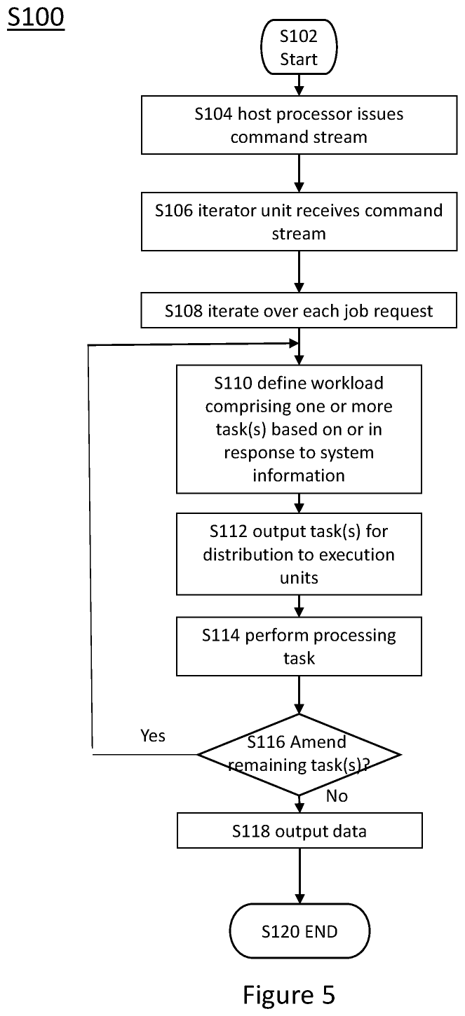

FIG. 5 schematically shows an example process for generating processing tasks at a data processing system.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter.

FIG. 1 is a simplified block diagram of a data processing system 1 in accordance with various representative embodiments.

Data processing system 1 includes a number of processing units, which in FIG. 1 are depicted as host processor 2 and target processor units, depicted here as graphics processor unit (GPU) 4 and Neural Processing Unit (NPU) 6. Data processing system 1 also includes storage 8, such as random access memory, and storage device 10, such as a solid state drive, hard disc or other non-volatile storage. The elements of data processing system 1 are connected via an interconnect 12, which may be a coherent interconnect, a network, or bus, for example.

The host processor 2 may comprise, for example, a general-purpose processing core, and is herein referred to as a central processing unit (CPU 2).

GPU 4 executes a graphics processor pipeline that includes one or more processing stages (“shaders”). For example, a graphics processor pipeline being executed by GPU 4 may include one or more of, and typically all of: a geometry shader, a vertex shader and a fragment (pixel) shader. These shaders are programmable processing stages that execute shader programs on input data to generate a desired set of output data.

In order to execute shader programs, GPU 4 includes one or more graphics execution units (circuit or circuits) for that purpose.

The graphics execution unit(s) (hereafter “graphics cores” or “cores”) on the GPU 4 comprise programmable processing circuit(s) for executing the graphics programs (e.g. shader programs). GPU 4 may comprise one or more cores, and in the following embodiments GPU comprises two or more cores for parallel processing of data, and any number of execution units could be used.

The actual data processing operations that are performed by the cores when executing a graphics program may be performed by respective graphics functional units (circuits) of the cores, such as arithmetic units (circuits), in response to, and under the control of, the instructions in the (shader) program being executed. Thus, for example, appropriate graphics functional units, such as arithmetic units, will perform data processing operations in response to and as required by instructions in a (shader) program being executed.

When executing an instruction in a graphics program, the cores (e.g. using the appropriate graphics functional unit, such as an arithmetic unit, of the execution unit), will typically perform a processing operation using one or more input data value(s) to generate one or more output data value(s), and then return the output data value(s), e.g. for further processing by subsequent instructions in the program being executed and/or for output (for use otherwise than during execution of the program being executed).

The input data values to be used when executing the instructions will typically be stored in storage (e.g. a cache or caches accessible to the core), and the output data value(s) generated by graphics functional unit(s) executing the instruction will correspondingly be written back to an appropriate storage (e.g. cache), for future use. Thus when executing an instruction, the input data value(s) will be read from an appropriate storage (e.g. cache or caches), and output value(s) written back to that same or different storage. Typically the data structures used to represent the data to be used for neural network processing (e.g. the input data array, the filters, the output data array, etc.) is multi-dimensional (e.g. 2D or 3D) image data.

NPU 6 typically comprises one or more neural execution units (hereafter “neural engine(s)”), where a neural engine is configured for more efficiently performing neural network processing operations of a particular type or types.

A neural engine may comprise one or more neural functional unit(s) to perform neural network operations. For example, a neural engine configured to perform tensor arithmetic operations, such as tensor MAC operations, may comprise a plurality of neural functional units in the form of multiplier-accumulator circuits (“MAC units”) which are arranged to perform such MAC operations on tensor data structures. Typically the data structures used to represent the data to be used for neural network processing (e.g. the input data array, the filters, the output data array, etc.) are multi-dimensional (e.g. 4D+ tensors). The arithmetic operations thus typically comprise tensor arithmetic, e.g. tensor multiplication, addition, and so on.

The NPU 6 may be coupled to or, as depicted in FIG. 2, integrated into the GPU 4 to provide neural processing capabilities for the GPU 4, whereby in embodiments each core of the GPU may have its own dedicated neural engine to provide neural network capabilities therefore. Alternatively, each core of the GPU may share a neural engine of the NPU 6 with one or more other GPU cores, with one neural engine providing neural network capabilities for each GPU sharing that neural engine.

Application 14, executes on host processor 2 and, in the present illustrative embodiments, requires graphics processing operations and/or neural network processing operations to be performed by a target processor (e.g. GPU 4 and/or NPU 6), where software driver 16 on the host processor 2 generates a command stream(s) to cause the target processor units 4, 6 to operate in response to the command stream(s).

In the present illustrative example, a command stream includes a call or request (hereafter “job request”) for a target processor unit(s) 4, 6 (using one or more functional units thereat) to perform one or more processing jobs or workloads (hereafter “job”), where processing a job comprises running a set of instructions or program (hereafter “program”) over a specified iteration space, where the iteration space comprises data.

The data may comprise input data for programs (e.g. shader programs of a graphics functional unit or neural network operations of neural network functional unit of the NPU 6). A functional unit will then run a specified program over the iteration space.

As will be described in greater detail below, the job request may comprise instructions, commands or indications (hereafter “indications”) relating to a requested job, for example to set parameters or define the properties or characteristics (hereafter “characteristics”) of the requested job.

An iterator unit at the target processor 4, 6 (i.e. the target processor for the job request) will iterate over or process each job request, and in response to, for example, job information therein, divide or partition the iteration space, into a workload comprising one or more processing task(s) (hereafter “task”) that are to be performed by a particular target processor unit 4, 6, where each task comprises a subset of the data in the iteration space specified for the job (i.e. task data). Performing (or processing) a task comprises applying, at an execution unit, a program over the task data.

The job information may include pre-defined parameters which specify the characteristics of each job such as the size (e.g. maximum or minimum size) and/or location of the iteration space thereof. The indication specifying the size and/or location of the iteration space may comprise one or more n-Dimensional coordinate(s) specifying an area in storage (e.g. a cache) storing the data over which a program should be run (e.g. a multi-dimensional data brick or block). The job information may also include pre-set or pre-defined parameters which specify the characteristics of a workload (e.g. defining the number of tasks into which a job should be divided; the no. of processors the tasks should be distributed between, size of the tasks etc.). The job information may also include indications to specify the types of processing operations required (e.g. graphics processing or neural network processing) etc.

The pre-defined parameters specifying the characteristics of the job(s) and/or workload(s) at the host processor 2 are set at the host processor that sends the job request (e.g. as part of an Application Programming Interface (API)).

FIG. 2 shows in more detail the components and elements of the target processor, which in the present illustrative example comprises a GPU 4 having NPU 6 integrated therein to provide neural processing capabilities. It will be appreciated that FIG. 2 shows those elements, units, communications paths, etc., that are particularly relevant to the operation in the manner of the present embodiments and the present invention. There may be other components, elements, communications paths, etc., that are not shown in FIG. 2, for example that may otherwise normally be present in a GPU or an NPU. Furthermore, although NPU is depicted as integrated into GPU 4, the NPU may, in alternative embodiments, be a standalone processor unit.

GPU 4 comprises a plurality of graphics cores 20₁ to 20ₙ (where n is an integer, n≥1). Each of the graphics cores 20₁ to 20ₙ of the GPU 4 includes one or more graphics functional units 32₁ to 32ₙ, operable to process a task by applying one or more shader programs over the task data.

Integrated NPU 6 comprises a plurality of neural engines 30₁ to 30ₙ, where, in the present illustrative embodiment, each neural engine of the plurality of neural engines 30₁ to 30ₙ is associated with a respective graphics cores 20₁ to 20ₙ to provide neural processing capability therefor, although in other embodiments two or more of the graphics cores may share the same neural engine or a single graphics core may share two or more neural engines.

As above, a neural engine, such as neural engine 30₁, includes a number of neural functional units 34, 36 configured to perform particular processing operations for neural network processing, such as, for example, a fixed function convolution unit 34₁ (that computes convolution-like arithmetic operations), and one or more other neural functional units 36₁ (e.g. that compute other arithmetic operations).

The operation of the appropriate graphics cores 20₁ to 20ₙ and neural engines 30₁ to 30ₙ is triggered by means of appropriate command streams comprising job request(s), that are generated and provided to the GPU 4 by host processor 2. Such command streams comprising job request(s) are generated, for example, by driver software at the host processor 2 in response to application(s) running thereon requesting for job(s) to be performed by the GPU 4.

GPU 4 comprises a command stream front end control circuit 22 having storage (e.g. a buffer) to receive and store the command stream(s) comprising the job request(s) generated by a host processor.

The control circuit 22 comprises iterator unit(s) (or job iterator unit) 24 to process or iterate through the job information, and divide each job into one or more workloads, each workload comprising one or more tasks. The iterator unit may also allocate each task to a particular execution unit and output the tasks for distribution (e.g. via a distribution manager) to one or more cores or engines in accordance with the job information.

However, relying on the job information to generate workload(s) having characteristics in accordance with the pre-defined parameters therein may cause the resulting tasks to have undesirable or unfavourable characteristics (e.g. inefficient sizing of tasks or inefficient distribution of tasks (to cores or engines)).

Although only a single iterator unit is depicted in FIG. 2, the claims are not limited in this respect and any number of iterator units may be provided.

FIG. 3a illustratively shows a diagram of iteration space 30a for a first job according to an example, where the iteration space 30a is divided into a workload comprising 27 tasks 0-26. In the present illustrative example, iterator unit attempts to generate a workload comprising 27 equal sized tasks using wrapping in accordance with the pre-defined parameters in the job information from a host processor. However, due to the actual iteration space available, attempting to adhere to the pre-defined parameters in the job information results in the iterator unit generating a final task 26 which, as depicted in FIG. 3a, is undersized or smaller relative to the fixed sized tasks 0-25.

FIG. 3b illustratively shows a diagram of iteration space 30b according to a further example, where the iteration space for the job 30b is, in accordance with pre-defined job information in the command stream, divided into twelve enumerated tasks 0-11 in two dimensions (L×W) without using wrapping. However, and as depicted in FIG. 3b, attempting to adhere to the parameters in the pre-defined job information results in iterator unit 22 generating a workload comprising undersized tasks at different edges of the iteration space for job 30b.

Providing the undersized tasks depicted in FIGS. 3a to 3b to the cores or engines would mean that the cores or engines performing the undersized tasks would complete performing the undersized tasks sooner than the cores or engines performing the full-sized tasks, and those cores or engines would be idle for a period of time whilst waiting for the other full-sized tasks of the job to complete, which is an inefficient use of the cores or engines.

In contrast to the functionality described and depicted, for example, at FIGS. 3a and 3b where the tasks are generated in response to pre-defined job information generated at a host processer (i.e. where the characteristics of the workload(s) are pre-defined in the job information), the present techniques provide for generating workloads comprising one or more tasks based on or in response to system information, where the system information is indicative of a status (e.g. a characteristic, a state etc.) of a component (e.g. hardware, software component, data) of the target processor unit, and preferably (substantially) real-time or current status of the component. Thus, at least one characteristic of the resulting workload (e.g. size and/or no. of tasks) is dependent on the system information.

Such system information may be stored in system information storage 28 (e.g. volatile and/or non-volatile memory). In the following illustrative examples the system information storage 28 comprises one or more status registers (not shown in FIG. 2). The system information storage 28 may be integrated as part of the GPU or may be part of the respective cores or engines.

The system information may be indicative of, for example, the state of the one or more cores or engines (e.g. graphics cores 20₁ to 20ₙ or neural network engines 30₁ to 30ₙ) such that when a particular core or engine changes from available or unavailable (or vice versa), the system information for that particular core or engine is updated in the system information storage 28.

The system information may also be indicative of, for example, the amount of current available storage (e.g. L1 or L2 cache),

By generating workloads comprising one or more tasks based on or in response to system information as an alternative or in addition to the predefined parameters of the job information, the iterator unit can generate workloads comprising one or more tasks having characteristics that provide for efficient processing compared to workloads generated in response to the pre-defined job parameters in the job information.

As an illustrative example, FIG. 3c shows a diagram of the iteration space 30a according to a further example, where the iteration space 30a is, as above in FIG. 3a, divided into a workload comprising tasks enumerated as 0-26 in accordance with the job information. However, in contrast to the example shown in FIG. 3a, the iterator unit takes account of the system information, and in particular the available iteration space for the job, and generates a workload comprising 27 equal sized tasks 0-26 based on or in response to the system information.

FIG. 3d illustratively shows a diagram of the iteration space 30b according to a further example, where the iteration space 30b is, as above in FIG. 3d, divided into a workload comprising enumerated tasks 0-11 in accordance with the job information. However, in contrast to the example shown in FIG. 3b, the iterator unit takes account of the system information, and in particular the available iteration space for the job, and generates a workload comprising twelve equal sized tasks 0-11 based on or in response to the system information.

Thus, the iterator unit can take account of available system information to determine how to divide a job into a workload comprising one or more tasks to provide a workload having characteristics (e.g. size of tasks, number of tasks etc.) that provide for efficient processing of those tasks.

The system information is not limited to being indicative of the status of iteration space, and any appropriate system information may be utilized to determine the characteristics of a workload and/or task(s) to provide, for example, efficient processing of a job. As a further illustrative example, the status information may be indicative of available execution units and the iterator unit may take account of the number of available cores or engines. As illustratively shown in FIG. 3e, when four execution units are available, the iterator may generate a workload comprising twenty-eight equally sized tasks for the iteration space 30d, and, allocate seven tasks to each of the four execution units in accordance with the system information. However, when three execution units are available, the iterator may generate a workload comprising twenty seven equally sized tasks for the same iteration space (as in FIG. 3c), and allocate nine tasks to each of the three execution units in accordance with the system information.

The system information may be indicative of the status of the jobs themselves, where one or more of the characteristics of a workload of a particular job may be dependent on the status of other jobs. As an illustrative example, the iterator unit 24 may receive, in a command stream, a relatively large first job (e.g. where the job information defines a relatively large iteration space) from which the iterator unit 24 determines a first workload having a relatively large number of tasks will be generated. The iterator unit 24 may also receive a second job (e.g. where the job information defines a relatively small iteration space, where such a second job may be a configuration job) from which the iterator unit 24 determines, as an illustrative example, that a second workload having a relatively small number of tasks will be generated, where in the present illustrative example the iterator unit 24 determines that the second workload comprises a single task.

In this illustrative example, the iterator unit 24 may divide the relatively large first job into a first workload comprising a plurality of tasks, such that all but one of the tasks of the first workload are equally sized, and where one of the tasks of the first workload is undersized relative to the others. Thus, the core allocated to perform the undersized task will complete processing sooner than the other cores allocated to the full-sized tasks, and will, thus, be available to process the single task of the second workload sooner than the other cores. Such functionality means that the second job can start without having to wait for the relatively large first job to complete all tasks of the first workload, which may be more efficient than splitting the first job into a workload having all equal sized tasks.

FIG. 4 shows in more detail the components and elements of the target processor 2, It will be appreciated that FIG. 4 shows those elements, units, communications paths, etc., that are particularly relevant to the operation in the manner of the present embodiments. There may be other components, elements, communications paths, etc., that are not shown in FIG. 4.

Control unit 22 receives a command stream includes one or more job requests, each job request comprising job information for a respective job of the one or more job requests.

Iterator unit 24 then processes or iterates over a job request of the one or more job requests, and in response to, for example, job information therein and/or system information, divides the iteration space (or the data therein), into one or more workloads each comprising one or more tasks that are to be performed. The iterator unit 24 allocates the one or more tasks to execution units to perform the tasks.

Iterator unit 24 outputs the tasks for distribution to the allocated cores or engines. In the present illustrative example, the iterator unit 24 outputs the tasks to be performed by the cores 20₁ to 20ₙ to GPU core distribution manager 44a and outputs the tasks to be performed by the neural engines 30₁ to 30ₙ to NPU distribution manager 44b. The appropriate distribution manager may then then schedule and distribute the tasks to the appropriate cores or engines to perform those tasks in accordance with the schedule. The schedule may be defined (or at least guided) by, for example, instructions from the iterator unit 24.

The distribution managers 44a & 44b may be part of the same control circuit 22 as the iterator unit 24 (as depicted in FIG. 4). In further embodiments the distribution managers may be located outside of the iterator unit, on the respective cores for example. Although depicted as separate units in FIG. 4, in further embodiments the distribution managers may comprise a single hardware or software component.

As set out above, iterator unit 24 may, for each job, divide a job into one or more workloads comprising one or more tasks based on or in response to system information, where at least one characteristic of the resulting workload(s) is dependent on the system information.

The system information may be updated/maintained in storage 28 at the GPU 4 (e.g. by firmware running at the GPU) and may be accessible by iterator unit 24.

As an illustrative example FIG. 4 depicts system information storage 28 as comprising status registers 29₁ to 29ₘ (where ‘m’ is an integer, where m≥1), where each register is to store, for example, one or more value(s), and to specify system information, such as the status of a hardware and/or software component of the GPU 4 (e.g. availability of cores or engines, available storage). For example, the status information may specify the availability of each core 20₁ to 20ₙ on the GPU 4. Additionally, or alternatively, the status information may specify the availability of each neural engine on the NPU 6 30₁ to 30ₙ.

Furthermore, the status information may be indicative of the status of data in storage, which the iterator unit 24 may use to determine how to split the iteration space into a workload comprising one or more tasks.

For example, the status information may specify how the data is laid out in storage (e.g. how the data is laid out in a cache), such that the task boundaries of tasks defined by the iterator unit 24 align with the data boundaries in storage (e.g. cache) to avoid two tasks accessing the same data. For example, and taking the data in storage (e.g. a cache) to be arranged in 1D row-major layout, to divide a job into a workload comprising one or more tasks, the X-axis may be divided in multiples of the cacheline size. As an illustrative example, for a datasize of 8 bits and a 512 bit cacheline, the X-axis may be divided into multiples of 64 elements.

Data may also be laid out in other layouts. For example, and taking the data in the cache to be laid out in two dimensions (2D) (e.g. height, width), where data laid out in 2D may comprise image data. When a bounding box defining an iteration space for a job in the cache is to be divided into a workload comprising smaller 2D tasks each having task boundaries, the system information in system information storage 28 may specify the properties or characteristics of the task boundaries for tasks such that the iterator unit 24 divides an iteration space defining a job into the workload comprising smaller tasks in accordance with the specified task boundaries. As an illustrative example, an 8 bit task may comprise 8×8 data elements (which is 64 data elements in one 512 bit cacheline), then this would require that each of the X and Y axes is divided in multiples of 8 elements.

As a further example, the data may be laid out in three dimensions 3D e.g. height, width, depth etc., where such data laid out in 3D may relate to tensor data. Thus an iteration space comprising a 3D block may be divided into a workload having tasks comprising sub-blocks, where the data in the sub-blocks is provided to a core or engine for processing.

Whilst the illustrative examples above describe data layouts in 1D, 2D and 3D. However the claims are not limited in this respect and may be any number of dimensions (e.g. 4D).

The status information may also define the status of workgroups e.g. on a graphics core. For example, for graphics tasks, the system information may specify e.g.: how big a workgroup is, how many threads are in such a workgroup, how much local storage (e.g. cache) a workgroup requires; how much local storage is currently available.

Thus, the iterator unit 24 can use the system information to determine which resource(s) of a core to prioritize and set the task size accordingly. As an illustrative example, a graphics workgroup having dimensions of 8×8×1 would require 64 threads. When the core to process that workgroup has a 2048 thread capacity, the maximum amount of workgroups that can be in flight in the core is 32, when only taking account of thread count. However, when each workgroup requires 1 kB of workgroup local storage, and only 16 kB is available in a core, the maximum number of workgroups that can run without saturating the local storage is 16.

Thus, solely relying on the maximum workgroup calculation based on the required number of threads and issuing 32 workgroups would mean that 16 workgroups would wait in a queue on the core, and could not start because the workgroup local storage may be saturated. This in turn would have adverse effects for scheduling at the tail end of a job as other cores may be idle until all tasks of the job complete. Thus by taking account of the system information, the iterator unit 24 could determine the most appropriate way to divide a job into a workload comprising one or more tasks.

The system information may be updated in substantially real-time (e.g. by firmware and/or by HW/SW components). An application running on a host application may not be aware of the change in system information and so would not be able to take the updated system information into account when issuing the command stream. Furthermore, the host application may generate the command stream well in advance of the command stream being executed, so even when the host application takes account of the number of available cores at the time the command stream is generated, it may not know the number of available cores at the time the command stream is executed. In fact, the same command stream might get executed more than once, with different number of cores available at each time.

For example, the number of cores available for a job to be executed on may change based on the mode of operation of the GPU (e.g. lightweight performance mode vs high operation performance; thermal performance). For example, a System Control Processor (SCP) may control the firmware to modify the core count or enforce a core power mask without FW involvement, although the claims are not limited in this respect. As a further example, when the GPU is virtualised the number of cores assigned to a virtual machine may change.

In accordance with the present techniques, the iterator unit may generate a workload having one or more tasks based on or in response to the system information. Thus, when, for example, one or more cores become available/unavailable, the system information will be updated, and a job divided into a workload having one or more tasks dependent on the current core count.

In addition to generating a new workload comprising one or more tasks based on system information, the iterator unit may amend previously generated tasks, such as tasks waiting to be performed (e.g. tasks in a queue at the respective distribution manager or the respective execution units to which they were distributed) based on updated system information. As an illustrative example, an iterator unit could, based on 3 cores being available, divide a job into a workload comprising 18 tasks, with each core being provided with 6 tasks each. When, during processing of those original 18 tasks, another core becomes available, the iterator unit may re-size the remaining tasks so as to be more efficiently processed by the 4 cores. Thus, dynamically updating how the remaining tasks are scheduled based on or in response to the updated system information means that, towards the end of a relatively large job, any remaining tasks (e.g. in a queue at a distribution manager) can be re-sized and/or distributed based on or in response to the updated system information.

The present techniques also provide for generating a workload comprising one more tasks based on or in response to policy information, where the iterator unit may apply one or more policy(ies) when generating workload(s), where a particular policy may, for example, define characteristics of a workload for particular processing operations. The iterator unit comprise policy storage 31₁ to 31ₚ (where ‘p’ is an integer) to store the policy information. The policy information may be updated, for example, in response to instructions from, for example, the host processor (e.g. as part of the job request). The iterator unit may then determine which policies to apply and may override policies when it is determined that applying a particular policy would result in tasks having undesirable characteristics.

In an illustrative example, the cost of performing tasks at a neural engine of NPU may increase with the number of tasks, and so an NPU policy may require that the iterator unit 24 reduce the number of tasks (or increase the size of the tasks) sent to an NPU. As a further illustrative example, the associated cost (e.g. processing cost, storage cost etc.) of performing a task at a GPU core is relatively small, but there may be a minimum number of tasks required to fill an internal task queue (not shown) of a GPU core, and so a GPU policy may, therefore, require that, for operations requiring graphics cores, the iterator unit 24 divides a job into a workload having a minimum number of tasks to fill the internal task queue of the GPU.

The techniques described herein provide for a job to be split into a workload comprising one or more tasks in a dynamic manner taking account of system information (e.g. real-time system information) in addition to or as an alternative to pre-defined job parameters received in the command stream from a host processor.

FIG. 5 shows an example process for generating tasks at a data processing system.

At S102, the process starts.

At S104, an application executing on host processor which requires one or more tasks to be performed by a target processor unit (e.g. GPU and/or NPU), transmits (e.g. using a software driver) a command stream(s) comprising a job request to the target processor unit for the target processor unit to perform a processing job. Each job request comprises job information comprising indications related thereto.

At S106, the target processor (i.e. the target of the job request) receives the command stream.

At S108 the iterator unit iterates over each job request, and at S110, divides the iteration space (or the data therein), into a workload having one or more processing tasks that are to be performed by execution units (e.g. graphics cores or neural engines) at the target processor unit, where at least one characteristic of the workload is based on or in response to the system information. For example, all tasks may be sized equally, or the job may be split into a number of tasks which is a multiple of the available cores, and allocated equally amongst the available cores. The system information may be maintained and updated in storage (e.g. at the target processor unit, such as the GPU).

At S112, iterator unit outputs the one or more task(s) for distribution to the appropriate execution unit(s). In the present illustrative example, the iterator unit may output the one or more task(s) to an appropriate distribution manager unit to distribute the tasks to the appropriate execution unit(s) (e.g. tasks to be performed by graphics core(s) are provided to a GPU core distribution manager unit and/or task(s) to be performed by a neural engine(s) are provided to NPU distribution manager unit).

At S114, each execution unit processes an allocated task received thereat, where, for example, a functional unit of the execution unit applies a required program over the task data in the received task.

At S116 the iterator unit may amend the processing tasks that are waiting to be executed (e.g. in a queue) based, for example, on updated system information. As an illustrative example, when, during processing of the previously defined tasks, another core becomes available (or a previously available core becomes unavailable), the iterator unit may re-size the remaining tasks so as to be more efficiently processed by the remaining cores. Thus, dynamically updating how the remaining tasks are scheduled based on or in response to the updated system information means that the remaining tasks can be re-sized and/or distributed based on or in response to the updated system information. At S118, the data resulting from processing the one or more tasks at the one or more execution unit(s) is output to one or more HW and/or SW components (e.g. stored in storage). At S120 the process ends.

Using the present techniques described above, an iterator unit at a data processor unit can process a processing job requested by a host processor, and dynamically generate tasks for that processing job by dividing an iteration space for that job (e.g. as defined in job information) into a workload comprising one or more tasks based on system information (e.g. real-time system information) of the data processor unit. At least one characteristic of the workload is dependent on the system information and the dynamically generated tasks may result in more efficient processing than could otherwise be achieved by tasks having all characteristics dependent on job information set by the host processor.

Furthermore, the techniques described above provide for dynamically defining the characteristics of a workload where, for example, the size and number of the tasks can be updated or changed based on or in response to any updates in the system information.

The techniques also provide for defining the characteristics (e.g. size) of tasks of the same workload to be different from one another based on or in response to system information. For example, one or more tasks of a workload could be undersized compared others of the same workload when determined to be appropriate (e.g. to allow a core performing the undersized task to start a task from a subsequent job sooner than would otherwise be allowed, for example, when the tasks are pre-defined by a host processor).

Whilst, the iterator unit can generate a workload comprising one or more tasks for a job based on or in response to the system information, the iterator unit may additionally take account of job information from the host processor or policy information when determining how best to divide a job. For example, the iterator unit may adhere to certain pre-defined task parameters in the job information when dividing a job into a workload comprising one or more tasks. For example, the iterator unit may respect a parameter in the job information specifying a threshold number of tasks (e.g. maximum or minimum) as defined by the host processor, and not exceed that threshold number of tasks when splitting a job into a workload.

As a further example, the iterator unit may respect a parameter in policy information specifying a threshold size of tasks and not exceed that threshold size when splitting a job into a workload comprising one or more tasks.

The techniques described above are applicable to processing operations on a target processor, such as graphics processing operations on a GPU or neural network operations on an NPU. In particular, the techniques are particularly applicable to parallel processing operations.

The data processing system described above may be arranged within a data system-on-chip system. The data processing system may be implemented as part of any suitable electronic device which may be required to perform neural network processing, e.g., such as a desktop computer, a portable electronic device (e.g. a tablet or mobile phone), or other electronic device.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; Band C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed.

The techniques further provides processor control code to implement the above-described systems and methods, for example on a general purpose computer system or on a digital signal processor (DSP). The techniques also provides a carrier carrying processor control code to, when running, implement any of the above methods, in particular on a non-transitory data carrier-such as a disk, microprocessor, CD- or DVD-ROM, programmed memory such as read-only memory (firmware), or on a data carrier such as an optical or electrical signal carrier. The code may be provided on a carrier such as a disk, a microprocessor, CD- or DVD-ROM, programmed memory such as non-volatile memory (e.g. Flash) or read-only memory (firmware). Code (and/or data) to implement embodiments of the techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™, VHDL (Very high speed integrated circuit Hardware Description Language) or SystemVerilog hardware description and hardware verification language. As the skilled person will appreciate, such code and/or data may be distributed between a plurality of coupled components in communication with one another. The techniques may comprise a controller which includes a microprocessor, working memory and program memory coupled to one or more of the components of the system.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended items.

What is claimed is:

1. A method of operating a data processor unit to generate processing tasks:
the data processor unit comprising:
a control circuit to receive, from a host processor unit, a request for the data processor unit to perform a processing job;
an iterator unit to process the request and generate a workload comprising one or more tasks for the requested job;
one or more execution units to perform the one or more tasks;
storage to store system information indicative of a status of at least one component of the data processor unit;
the method comprising:
receiving, at the control circuit, a first request to perform a first processing job;
processing, at the iterator unit, the first request and generating a workload comprising one or more tasks for the first processing job based on or in response to the system information in storage, wherein at least one characteristic of the workload is dependent on the system information.

2. The method of claim 1, where the system information comprises real-time or current system information.

3. The method of claim 1, where generating the workload comprises dividing an iteration space for a job into one or more tasks, where the number of tasks generated is dependent on the system information and/or where the size of each task generated is dependent on the system information.

4. The method of claim 1, further comprising:
allocating the tasks to one or more execution units, where the number of tasks allocated to a particular execution unit is dependent, at least in part, on the system information.

5. The method of claim 1, where the data processing unit comprises a plurality of execution units and the first job comprises a plurality of tasks, the method comprising:
determining, using the system information, an availability status of each execution unit of the plurality of execution units;
allocating tasks of the plurality of tasks between execution units that are available to process tasks allocated thereto.

6. The method of claim 1, further comprising:
updating the system information at the data processor unit in response to a change in the status of the at least one component.

7. The method of claim 6, further comprising:
receiving, at the control circuit, a further request to perform a further processing job;
processing, at the iterator unit, the further request and generating a further workload comprising one or more tasks for the further processing job based on or in response to the updated system information in storage, wherein at least one characteristic of the further workload is dependent on the updated system information.

8. The method of claim 6, further comprising:
amending, at the iterator unit, one or more of the previously generated tasks based on or in response to the updated system information, wherein at least one characteristic of the one or more amended tasks is dependent on the updated system information.

9. The method of claim 8, wherein amending the one or more previously generated tasks comprises one or more of: resizing at least one of the tasks or reallocating at least one of the tasks to a different execution unit.

10. The method of claim 1, wherein the system information is indicative of a current status of at least one component at the target processor unit.

11. The system of claim 10, where the status of the least one component comprises: a storage unit; an execution unit; a processing job; a processing task.

12. The method of claim 1, further comprising:
generating the workload based on or in response to policy information in storage at the target processor unit.

13. The method of claim 1, further comprising:
generating the workload based on or in response to job information in the first request from the host processor, where the job information comprises pre-defined parameters which specify the characteristics of the first job.

14. The method of claim 1, further comprising outputting the one or more tasks for distribution to the one or more execution units to perform the respective tasks allocated thereto, where the one or more execution units comprise graphics cores or neural engines.

15. A data processor unit to generate processing tasks:
the data processor unit comprising:
a control circuit to receive, from a host processor unit, a request for the data processor unit to perform a processing job;
an iterator unit to process the request and generate a workload comprising one or more tasks for the requested job;
one or more execution units to perform the one or more tasks;
storage to store system information indicative of a status of at least one component of the data processor unit;
wherein the iterator unit is to generate the workload comprising one or more tasks for the requested job based on or in response to the system information in storage such that at least one characteristic of the workload is dependent on the system information, and where the iterator unit is to output the one or more tasks for distribution to one or more execution units.

16. The data processor unit of claim 15, where the data processor unit comprises one or both of: a graphics processor unit and a neural processor unit.

17. The data processor unit of claim 15, where the iterator unit is configured to dynamically update a characteristic of the workload based on or in response the system information.

18. A non-transitory computer readable storage medium comprising code which when implemented on a processor causes the processor to:
control operation of a data processor unit, the data processor unit comprising:
a control circuit to receive, from a host processor unit, a request for the data processor unit to perform a processing job;
an iterator unit to process the request and generate a workload comprising one or more tasks for the requested job;
one or more execution units to perform the one or more tasks;
storage to store system information indicative of a status of at least one component of the data processor unit,
wherein the code when implemented on the processor further cause the processor to:
detect receipt, at the control circuit, of a first request to perform a first processing job; and
initiate the iterator unit to process the first request and generate a workload comprising one or more tasks for the first processing job based on or in response to the system information in storage, wherein at least one characteristic of the workload is dependent on the system information.
